(19) United States
(12) Patent Application Publication
(10) Pub. No.: US 2013/0041788 A1
(43) Pub. Date: Feb. 14, 2013

(54) Method and System for Calculating and Reporting Fund Values for Omnibus Investment Accounts

(71) Applicant: Thomas A. Nieman, Austin, TX (US)

(72) Inventor: Thomas A. Nieman, Austin, TX (US)

(73) Assignee: SALI FUND MANAGEMENT, LLC, Austin, TX (US)

(21) Appl. No.: 13/205,395

(22) Filed: Aug. 8, 2011

(51) Int. Cl. G06Q 40/00

(52) U.S. Cl. 705/30

(57) ABSTRACT

An omnibus fund accounting system is described that comprises a system of servers and databases connected to a network that can host a set of application instructions and a fund investment database to manage multiple fund investments. An institutional investor places an investment with an investment fund. The institutional investment comprises a plurality of individual investors who may invest at varied times and in varied amounts. The discrepancies in investment initiation dates by individual investors causes expenses such as performance based management fees to be assessed differently against each individual investor. The omnibus fund accounting system tracks the increases or decreases in overall fund performance with respect to the institutional investment or, alternatively, with respect to the fund as a whole. This may be reflected by the overall net asset value of the institutional investment or the fund as a whole as determined by the omnibus fund accounting system. The omnibus fund accounting system also accommodates the deviations in costs attributable to each individual investor while tracking the overall institutional investment performance. The omnibus fund accounting system may accommodate deviations in costs for each individual investor with the addition of positive unit adjustments or subtraction of negative unit adjustments to or from individual accounts. The omnibus fund accounting system reports the performance of the individual investments and the overall institutional investment to the institutional investor.

### FIELD OF THE DISCLOSURE

The present disclosure generally relates to electronic omnibus fund accounting, and relates more particularly to an electronic accounting and reporting system for omnibus investment funds.

### BACKGROUND

A computer generally processes and stores data. Computers are further configured to compile information and communicate data for business, personal, or other uses. The requirements of applications that execute instructions on computers can impact how information is handled, stored, processed and communicated. Computers may be configured and include hardware, software, or firmware according to either general or specific use. Examples of specific use include, but are not limited to, financial transaction processing, data processing, storage, or network communications.

Institutional investors, for example insurance companies, frequently make investments into an investment fund. The investment fund may include any type of hedge fund. For institutional investors, the investment in a fund may comprise the investment of multiple individual investors. In the example of insurance company investors, the multiple individual investors may include individual policy holders. It would be beneficial to facilitate processing and management of these financial transactions with application instructions stored and executed on a computer.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a network including servers, personal computer, and mobile devices that may be used to perform the methods and implement the omnibus fund accounting system described herein;

FIG. 2 is a flow chart illustrating one embodiment of the omnibus fund accounting system used to calculate the net asset value (NAV) for a fund as described herein;

FIG. 3 is a flow chart illustrating one embodiment of the omnibus fund accounting system used to calculate the unit adjustments for investors in an omnibus investment account with a fund investment; and

FIG. 4 is a block diagram of a general computer for storing and executing the processor instructions to operate the omnibus fund accounting system described herein.

### DETAILED DESCRIPTION OF THE DRAWINGS

An omnibus fund accounting system is described that comprises a system of servers and databases connected to a network to process executable application instructions to process the methods described herein. The application instructions of the omnibus fund accounting system are stored in at least one computer readable medium such as a database. The omnibus fund accounting system and method accommodate plural institutional investors investing as part of an omnibus fund investment placed by an institutional investor. By way of example herein, an institutional investor may include an insurance company. The institutional investor may have multiple individual investors that comprise the overall institutional investment. Several institutional investors may invest simultaneously in one investment fund administered by the omnibus fund accounting system. Using the example of an insurance company institutional investor, the individual investors comprising the insurance company's investment account may include individual life insurance policy holders.

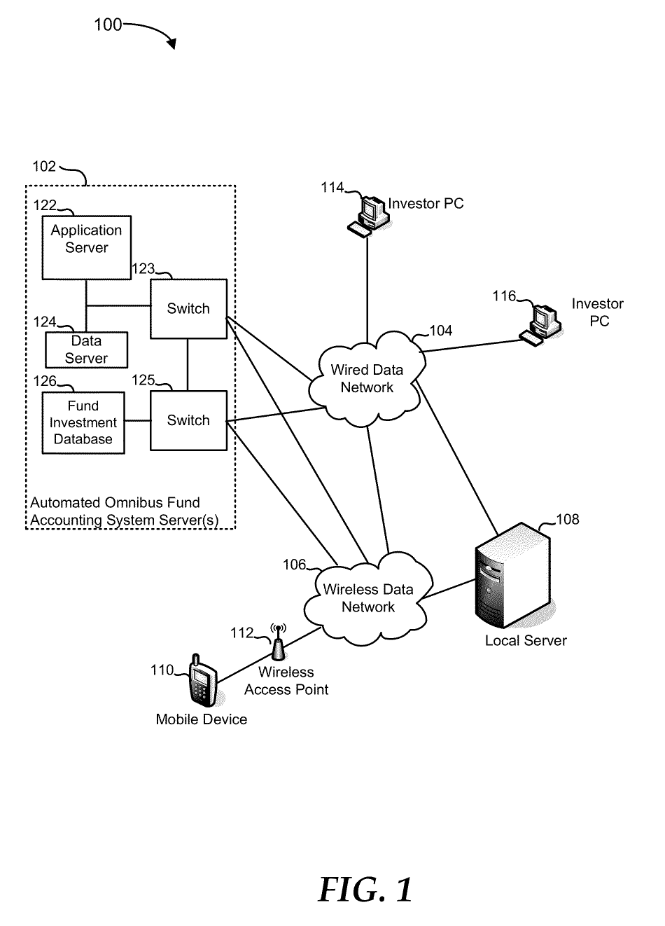

In FIG. 1, the financial services company servers and computers 102 operate a computer-implemented method to administer the fund investment made by the institutional investor on behalf of multiple individual investors. This computer-implemented method comprises the omnibus fund accounting system described herein. The terms computer and server may be used interchangeably herein.

An institutional investor, such as the example insurance company, may place an investment with an investment fund. This investment may be placed via a computer connected to a network as depicted in FIG. 1. The institutional investor passes investment data to one or more computers or servers controlled by a financial services company offering fund investments to the institutional investor. The omnibus fund accounting system operates on the one or more computer systems or servers of the financial services company and may securely interface with a network, such as the Internet, that may include wired and wireless portions. FIG. 1 shows a block diagram for a network system 100 for use in connection with the omnibus fund accounting system and process according to one embodiment. The system 100 includes a set of servers 102 including a fund investment database 126. The set of servers, including 122 and 124 and database 126, host at least portions of the omnibus fund accounting system described herein. The omnibus fund accounting system described is implemented in software running on the computer hardware that comprises the servers and the database depicted at 102.

The set of servers 102 with database 126 may be coupled to the wired data network 104 via a switch or switches 123 and 125 or some other interface or set of interface devices. The servers 102 may be coupled to a wired data network 104 that can be a global network, a wide area network, a local area network or other version of network. In an example, the wired data network can include all or some portion of the Internet. It also may be coupled to a wireless network 106. The wireless network 106 can include one or more of the following well known networks: WiFi networks, WiMAX networks, Bluetooth networks, WiLAN networks, CDMA, TDMA, or other types of cellular networks. The wireless system can include a local server 108 that can couple the wired data network with the wireless network. The wireless network may couple the wired network with one or more mobile devices 110 via wireless access points 112. An institutional investor's computer or computers 114 may be coupled to the wired data network 104 or alternatively to the wireless data network 106 (not shown) via one or more interface devices or wireless transmission/reception devices as appropriate. Several institutional investor computers 116 may be coupled to the same network system 100.

The investment data may be passed to the financial services company computers or servers 102 via one or more secured network connections. Various security measures may be used to protect the electronic investment data including encryption, password protection, secured file types, secured data transfers, and similar types of security strategies. Alternatively, this investment data may be received by the financial services company in a variety of other conventional ways, such as via wire transfer, email, mail, personal delivery or other method that is independent of the network connection to the financial service company computers or servers operating the omnibus fund accounting software system. The investment data may be assembled and manually entered into and received by the one or more servers or computers of the financial services company. The omnibus fund accounting system may be implemented on the financial services company servers and database 102 to administer the fund investment. Manually entered investment data avoids the need for the financial services company computers or servers to be connected via an outside network connection such as connection to the Internet. Eliminating or reducing the connections to public or even private networks reduces the inherent risks associated with electronic investment data transfer from an institutional investor.

The investment data received at the one or more financial services company computers or servers is received by and stored in the fund investment database 126. The fund investment database 126 is controlled and administered by the servers 102 which host the omnibus fund accounting system. While some data or other information may be stored or cached in other locations during operation, e.g. a local server 108 within a wider network, the omnibus fund accounting system is generally hosted on one or more origin servers 102 connected to a financial services company computer network 104. Each institutional investor submitting investment data to the omnibus fund accounting system may be assigned a unique institutional investor identification number.

The investment data received from an institutional investor may include a wide variety of information. The investment data received can comprise information identifying the institutional investor, the individual investors, account numbers, money transfers, balance amounts, additional investment amounts, selection of funds to invest in, customer preferences, investment timing information, and many other relevant types of investment data. By way of example, the investment data can be received in a wide variety of formats including an HTML file format or other similar data file for storage in the fund investment database 126.

One or more institutional investors may invest in an investment fund. Investment funds often have various expenses associated with them which may be subtracted from the account balances of the institutional investors. For example, fund management fees are a cost assessed against fund investments. These fees can include a fixed management fee to cover basic costs of operating the fund. The fixed management fees are often a percentage of the balance in value of the fund.

The fund management fees can also include a performance-based fee. The performance based fee serves to align the interests of the fund managers with the investors. A performance based fee is a percentage of profit or return on the investment charged over a specified time period such as a fiscal year, fiscal quarter, or fiscal month. The percentage by a performance based fee is often a higher percentage than the fixed management fee of the fund. The performance based fees may be tied with the fund performance as it relates to an individual investor within the institutional investment. As such, when an institutional investment includes numerous component individual investors, accounting for the performance based fee associated with each investor becomes complicated. Assessing performance fee costs to the individual investors in an omnibus fund investment in a fund by an institutional investor is complicated by a time component associated with the performance based fee. Not all individual investors will have the same return. Investment returns will depend on the timing of the initial investments and the period of time considered in the calculations.

Performance based fees may be limited in several ways. One way to limit the performance based fee is to implement a high water mark or loss carry-forward approach. With this limitation, a performance based fee is not charged unless the fund net asset value exceeds its own historical high. The net asset value (NAV) is analogous to a share value in the fund. The NAV is the value of the fund divided by the number of units or shares investing in the fund. The high-water mark may be determined based upon the NAV peak over a fixed time period within the life of the investment or over the duration of the investment with the fund. The high-water mark for individual investors may differ depending upon when the individual investor entered the institutional investment with the fund. For example, two individual investors, A and B, invest in a fund where each individual investor may make an investment at a different time. Individual investor A may have invested in January of a given year when the NAV per unit of the fund is $100/unit. Three months later in April, individual investor B may invest when the NAV per unit of the fund has dropped to $80/unit. In the example year, the fund achieves $90/unit in December. Individual investor A does not hit a high water mark year since the NAV has not exceeded $100/unit. Individual investor A will not be charged a performance fee. Individual investor B, however, has exceeded a NAV high-water mark of $80/unit and can be charged a performance fee in December.

Another way to limit the performance based fee is to set a hurdle rate. The hurdle rate is a benchmark rate of return, such as a T-bill rate. The financial services company may not charge a performance based fee unless the fund return on investment performance exceeds the hurdle rate. The rates used for comparing the fund performance with the benchmark may be an annualized rate for both or it may be based on some other specified time period. Whether the fund performance exceeds the hurdle rate can determine both whether and how much performance fee is charged. The hurdle rate relevant to each individual investor therefore may differ depending on when the individual investor made an investment in the fund. As with the high-water mark calculation, this time-dependent calculation complicates accounting for an institutional investment comprised of multiple individual investors with investments beginning at various times.

Returning to the example of the two individual investors A and B investing in the fund at different times, the hurdle rate limitation is illustrated. Individual investor A may have invested in January of a given year when the NAV per unit of a fund is $100/unit. Three months later in April individual investor B may invest when the NAV per unit of the fund increased to $110/unit. If the example hurdle rate is an annualized return rate of 10%, the investments must exceed a 10% return to be charged a performance fee. In December, the NAV of the fund is $115/unit. Individual investor A has a 15% return and has exceeded the hurdle rate of 10%. Individual investor A will be charged a performance fee. Individual investor B, however, has only achieved about a 4.3% return and does not exceed the hurdle rate. Individual investor B will not be charged a performance fee in December of this example.

The disclosed omnibus fund accounting system is useful to administer several types of investment funds. One type includes, for example, a hedge fund. Hedge funds are a specific type of investment fund employing a variety of investment strategies to protect investments during market downturns while simultaneously optimizing returns during growth periods. Hedge funds may include performance based fees as at least a portion of the overall management fees charged. Hedge fund performance based fees may also be subject to high-water marks and hurdle rate limitations as well as other limitations.

Hedge funds come in a variety of types. Example hedge fund types include global macro hedge funds, directional hedge funds, event driven hedge funds, and relative value arbitrage hedge funds. The types of hedge funds reflect the investment strategies used to balance growth and risk protection tactics. Additionally, funds may be used to invest in other hedge funds, sometimes referred to as a hedge fund of funds. These and other types and sub-types of funds and hedge funds can be used with the disclosed omnibus fund accounting system. However, hedge fund has also come to mean any type of securities-based investment that is not regulated in the same way as mutual fund investments whether or not the investment is actually hedged. The omnibus fund accounting system disclosed herein is in no way meant to be limited to hedge funds. A wide variety of investment funds are contemplated having variations on individual investment balances depending on time components of each investment.

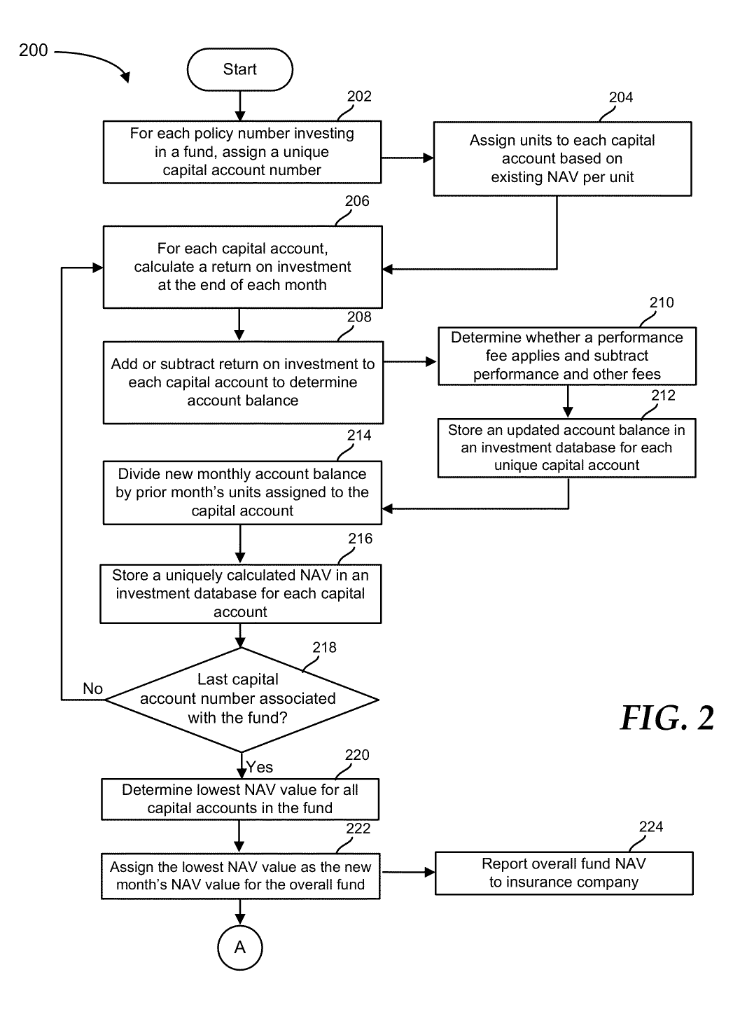

FIG. 2 shows how the omnibus fund accounting system tracks an institutional investment NAV upon receipt of investment data by the financial services company at one or more computers or servers 102. Data is tracked for the overall institutional investment in the fund and also with respect to the individual investors that comprise the institutional investment. This process shown in FIG. 2 relates to a specific embodiment where the institutional investor is an insurance company providing life insurance policies and the individual investors are policy holders. It is understood that the institutional investor may be an organization other than an insurance company providing investment opportunities. It is also understood that the individual investors may be other than purchasers of life insurance policies, and may be the purchasers of other financial instruments instead. One example of an alternative financial instrument that may be used with the disclosed system and method includes individual investment in annuity contracts.

In the embodiment depicted in FIG. 2, investment data stored in the fund investment database 126 includes policy holder information in the insurance company investment in the fund. At 202, the omnibus fund accounting system assigns a unique capital account number for each policy number disclosed. The individual investor data may include investment amounts for each policy account, time of investment, fund units assigned to that investment, NAV of the units assigned to the fund, historical investment performance data, as well as other information associated with each policy holder. The capital account number assigned includes a date stamp indicating the timing of the one or more investments associated with the capital account number. Alternatively, multiple investments by a policy holder may be assigned multiple capital account numbers in the fund investment database 126 and each is associated with the individual policy holder.

The omnibus fund accounting system maintains a NAV for the investment fund. The omnibus fund accounting system may maintain NAVs specific to each institutional investor, specific to each individual investor, or for the entire fund. The NAV may be calculated on a monthly basis, daily basis or based on some other fixed time period. In the described embodiment of FIG. 2, the NAV is calculated on a monthly basis. For example, at the end of the fiscal month in which the calculation is made, the NAV for the fund is assigned. A fiscal month may or may not correspond exactly with a calendar month. For example, a fiscal month may begin mid-calendar month and end mid-calendar month. Alternatively, a fiscal month may correspond with the standard 12 month annual calendar.

The omnibus fund accounting system assigns a number of units to each capital account at 204 based on the initial investment amount and the NAV of each unit. In the example of individual investor A and individual investor B, each individual investor may make an investment in the fund at a different time. Individual investor A may have invested $10,000 in January of a given year when the NAV per unit of the fund is $100/unit. Investor A is assigned 100 units. Similarly, three months later at the beginning of April, individual investor B may invest $10,000 when the NAV per unit of the fund has dropped to $80/unit. Investor B is assigned 125 units. For simplicity, we assume at the beginning of April that individual investor A still has 100 units with an account balance of $8,000.

At the end of the next fiscal month, the omnibus fund accounting system calculates a return on investment for each capital account number as shown at 206. The return on investment is the increase or decrease in the value of the fund at the end of the month divided by percentage attributable to each individual investor determined by the number of units assigned to their capital account at the beginning of the month. This amount is then added to or subtracted from the account balance of the capital account number of the policy holder at 208. In the example of individual investors A and B, we assume the fund increases by 10% by the end of April. Individual investor A's account balance now stands at $8,800. Individual investor B's account balance stands at $11,000.

As shown at 210, the omnibus fund accounting system determines whether and how much the fund investments are affected by expenses assessed against the fund. Among those are the fixed management fees. Fixed management fees may be assessed equally against all units in the fund and based on the value of the capital account. Performance based fees are assessed for each capital account on the return yielded. Performance based fees are limited, as described above, depending on whether the investment fund exceeded either or both of a high water mark and a hurdle rate for each capital account. The performance based fee assessed against the capital account depends, therefore, on when the policy holder investment was made. For example, a high water mark may have been reached for one individual investor triggering a performance based fee, but not for another individual investor who entered the investment at an earlier time when the fund had a higher value but was subject to later downturns in value.

Similarly, a hurdle rate is subject to differences among individual investors. An earlier individual investor may be charged a performance based fee if the return on investment over a period of time exceeds a hurdle rate. A later individual investor however may not have reached the annualized benchmark rate of return in the shorter investment time. The later investor would not be charged a performance based fee. Thus, the performance based fee will vary among capital accounts in an institutional investment with the fund.

In the example of individual investors A and B, we focus on whether a performance fee is assessed and calculate an updated balance for the end of April. In this example, we only look at the high water mark limitation. Since the high water mark was reached for B but not A, individual investor B is charged a performance fee of 10% of profit but individual investor A is not. We assume other fees and costs amount to 0.5% of investment value. The updated account balance for individual investor A is $8,800 less other fees and costs to yield $8,756. Individual investor B has an updated account balance of $11,000 less a performance fee and other fees and costs to yield an updated account balance of $10,845.

At 212 of the described embodiment, the new capital account balance, after the performance fees and other fees have been subtracted, is stored in the investment database. Each capital account may have a unique balance at this point because of the differences in assessed performance fees. The omnibus fund accounting system of the disclosed embodiment divides each new capital account balance for the month by the number of units assigned to the account from the prior fiscal month at 214. This generates an interim NAV specific to each capital account. If there were differences in performance based fees assessed against each capital account, the interim NAV is unique for each capital account. Those capital accounts having no differences in the fees assessed because of identical investment timing should retain the same NAV although uniquely calculated for each account. The uniquely calculated NAV for each capital account is stored in the fund investment database at 216 for each assigned capital account number.

We return to the example of the updated account balances for individual investor A of $8,756 and individual investor B of $10,845. Individual investor A had 100 units at the beginning of April and individual investor B had 125 units at that time. For individual investor A, the uniquely calculated interim NAV is $87.56/unit. For individual investor B, the uniquely calculated interim NAV is $86.76/unit.

At 218 of the disclosed embodiment, the omnibus fund accounting system determines if the last capital account number associated with the fund has had a uniquely calculated NAV stored in the fund investment database 126. If not, the omnibus fund accounting system returns to 206 for each remaining capital account in the institutional investment. If all capital account numbers have uniquely calculated NAVs associated with them, then the omnibus fund accounting system proceeds to 220.

The omnibus fund accounting system determines the lowest uniquely-calculated NAV for all capital account numbers associated with the institutional investment in the fund at 220. Between individual investors A and B in the example, the lowest value is $86.76/unit. Upon determining the lowest NAV for all capital accounts associated with one institutional investor, this lowest value is assigned as the new month's overall NAV for the institutional investment at 222. This institutional NAV is reported to the institutional investor at 224. Alternatively, the omnibus fund accounting system can determine the lowest NAV for all capital accounts in the entire investment fund, including for all institutional investors, at 220. Then this lowest NAV may be assigned as the new month's overall NAV for the fund at 222. This new overall NAV is reported to each institutional investor at 224. The process shown in FIG. 2 permits the financial services company to report the NAV performance overall for each institutional investment or for the entire fund.

In an alternative embodiment, any uniquely-calculated NAV for any capital account may be taken as the new month's overall NAV for the fund at 222. For example, the omnibus fund accounting system may alternatively determine the median uniquely-calculated NAV for the capital accounts at 220 or it may determine the average uniquely-calculated NAV for the capital accounts at 220. In one embodiment, the omnibus fund accounting system may even determine the highest uniquely calculated NAV for the capital accounts at 220 and assign that value as the new month's overall fund NAV at 222.

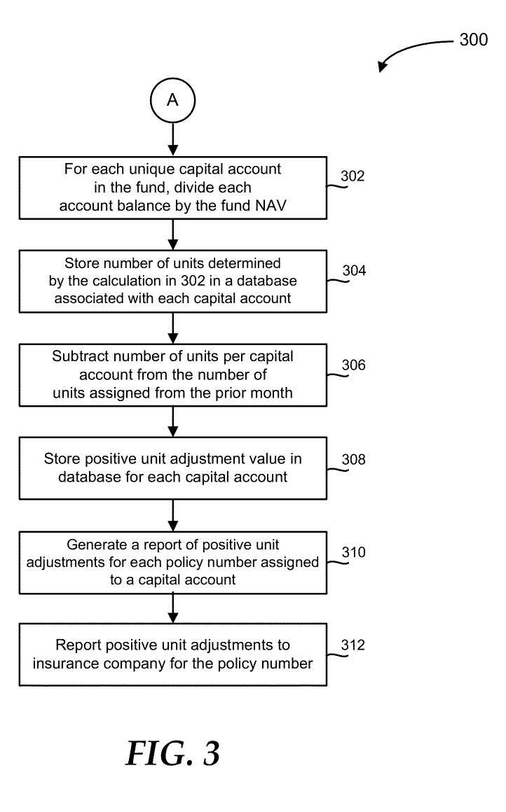

FIG. 3 of the disclosed embodiment shows the omnibus fund accounting system calculation of unit adjustments for each individual capital account. Unit adjustments account for a fair assessment of performance based fees to each individual investor. FIG. 3 also discloses the specific embodiment of an insurance company institutional investor and individual investor policy holders. The omnibus fund accounting system calculation begins at 302.

At 302, the system divides the account balance associated with each capital account number by the new month's overall fund NAV. Alternatively, the new month's overall NAV for each institutional investment may be used. This yields a number of units specifically attributed to the capital account based on the new NAV.

We return to the example of the updated account balances for individual investor A of $8,756 and individual investor B of $10,845. We assume the lowest capital account interim NAV is that of individual investor B and therefore the overall NAV is $86.76/unit. The number of units attributed to individual investor A at the end of April is investor A's updated account balance divided by the overall NAV yielding 100.92 units. Individual investor B's account is unchanged at 125 units since the overall NAV equaled investor B's interim NAV. It may be appreciated that another uniquely-calculated interim NAV may be adopted as the overall fund NAV for the month that may yield different results.

For capital accounts with uniquely calculated NAVs equal to the new overall NAV (i.e., the lowest calculated NAVs), no change in the number of units will occur. For all other capital accounts, the new number of units will be greater than the month before. The new number of units fairly balances assessment of the performance based fees among the individual policy holders depending upon the timing of the policy holder investments.

By accounting for the changes in capital accounts this way, the omnibus fund accounting system avoids the socialization of assessing performance fees against the institutional investment as a whole that characterized past accounting systems used with funds having performance based fees having a time-dependent component. The omnibus fund accounting system accounts for the unique situation for each individual investor in the institutional investment with the fund. The omnibus fund accounting system calculation also permits the financial services company to report overall performance of the institutional investment in the fund to the insurance company or other institutional investor.

At 304 of the embodiment described in FIG. 3, the new month's number of units determined at 302 for each capital account number is stored in the fund investment database 126. The omnibus fund accounting system subtracts the new month's units assigned to the capital account number from the number of units assigned to the capital account at the end of the previous month as shown at 306. This generates a positive unit adjustment value for each capital account number. At 308, the positive unit adjustments are stored in the fund investment database 126.

If an uniquely-calculated interim NAV other than the lowest NAV value was assigned as the new month's overall fund NAV in an alternative embodiment, then it can be appreciated that certain capital accounts will have negative unit adjustments while others will have positive unit adjustments at 306. In the alternative embodiment, these positive and negative unit adjustments will be stored in a fund investment database at 308.

Returning to the example of individual investors A and B, the number of units attributed to individual investor A at the end of April increased from 100 units to 100.92 units, the positive unit adjustment for individual investor A is 0.92 units. Individual investor B's account remained unchanged at 125 units and the unit adjustment for individual investor B is 0 units.

At 310, the omnibus fund accounting system of the disclosed embodiment assesses the policy number associated with each capital account or accounts and generates a report showing the unit adjustments for each investment by that policy number. In the example shown in FIG. 3, positive unit adjustments are disclosed, however positive, negative and zero unit adjustments are contemplated. These unit adjustments are reported by the financial services company to the institutional investor as shown at 312 of the embodiment of FIG. 3.

While the disclosed embodiment depends on monthly fund assessments and accounting, it is understood that such an omnibus fund accounting system could be used with a more frequent fund value assessment and accounting. The present monthly embodiment is not meant to limit the present disclosure to an omnibus fund accounting system using only monthly NAVs and unit adjustments Annually, quarterly, weekly, daily, hourly, by the minute and any longer or shorter time periods are contemplated.

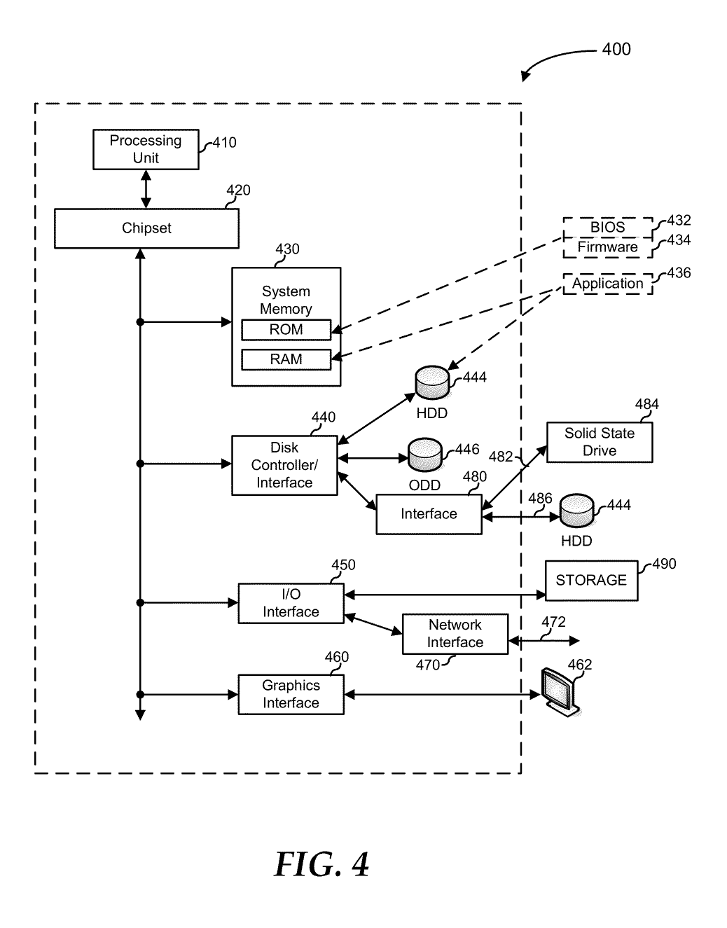

FIG. 4 is a block diagram illustrating an embodiment of a computer or server system 400, including a processing unit 410, a chipset 420, a system memory 430, a disk controller/interface 440, an input/output (I/O) interface 450, graphics interface 460, and a network interface 470. In a particular embodiment, the computer or server system 400 is used to carry out one or more of the methods described herein. In another embodiment, one or more of the computer or server systems described herein are implemented with a storage database to host the omnibus fund accounting system and carry out the methods described herein.

Chipset 420 is connected to processing unit 410 via a bus or other channel, allowing the processing unit to execute machine-executable code. In a particular embodiment, computer or server system 400 may include one or more processing units. Chipset 420 may support the multiple processing units and permit the exchange of data among the processing units and the other elements of the computer or server system. A bus or other channel permits the system to share data among the processing unit, the chipset, and other elements of computer or server system 400.

System memory 430 is connected to chipset 420. System memory 430 and chipset 420 can be connected via a bus or other channel to share data among the chipset, the memory, and other elements of computer or server system 400. In another embodiment, processing unit 410 may be connected to system memory 430. A non-limiting example of system memory 430 includes static random access memory, dynamic random access memory, non-volatile random access memory, read only memory, flash memory, or any combination thereof.

Disk controller/interface 440 is connected to chipset 420. Disk controller/interface 440 and chipset 420 can be connected via a bus or other channel to share data among the chipset, the disk controller, and other elements of computer or server system 400. Disk controller/interface 440 is connected to one or more disk drives. Such disk drives may include an internal or external hard disk drive (HDD) 444, and an optical disk drive (ODD) 446, and can include one or more disk drives as needed or desired. ODD 446 can include a Read/Write Compact Disk (R/W-CD), a Read/Write Digital Video Disk (R/W-DVD), a Read/Write mini Digital Video Disk (R/W mini-DVD), another type of optical disk drive, or any combination. Additionally, disk controller 440 is connected to disk interface 480. Disk interface 480 permits a solid-state drive 484 or external HDD 444 to be coupled to a computer or server system 400 via an external interface 482. External interface 482 can include industry standard busses such as a Universal Serial Bus (USB), IEEE-1394 Firewire, or other proprietary or industry-standard busses. Solid-state drive 484 can alternatively be disposed within the computer or server system 400. Any of the above drivers, individually or in combination, may serve as the database storage for the omnibus fund accounting system. Alternatively, network links may connect to off-site memory or storage devices to save data as part of a fund investment database. I/O interface 450 may include an I/O controller and is connected to chipset 420. I/O interface 450 and chipset 420 can be connected via a bus or other channel to share data among the chipset, the I/O interface, and other elements of computer or server system 400. I/O interface 450 is connected to one or more peripheral devices via possible intermediate channels and devices. Peripheral devices can include devices such as including a keyboard, mouse, or storage systems 490, graphics interfaces, network interface cards 470, sound/video processing units, or other peripheral devices. Network interface 470 includes one or more network channels 472 that provide an interface between the computer or server system 400 and other devices that are external to computer or server system 400. This includes an interface between the computer or server system 400 that may host the omnibus fund accounting system and various wired and wireless networks connected to the mobile devices or computers of consumer members and merchants for executing the methods and system described herein.

Graphics interface 460 is connected to chipset 420 via a bus or other channel which permits exchange of data among the chipset, the graphics interface, and other elements of computer or server system 400. Graphics interface 460 is connected to a video display 462.

Computer or server system 400 includes Basic Input/Output System (BIOS) 432 and firmware code 432, and one or more application programs 436. BIOS code 432 functions initializes the computer server system 400 on power up to launch an operating system, and to manage input and output interactions between the operating system and the other elements of the computer or server system. In a particular embodiment, the BIOS 432 and firmware code 434 and application programs 436 are stored in memory 430. The BIOS code 432, firmware 434, and application programs 436 include machine-executable code that is executed by processing unit 410 to perform various functions of computer or server system 400. In another embodiment, the BIOS code 432, firmware 434, and application programs 436 are stored in another storage medium of computer or server system 400. The BIOS code 432, firmware 434, and application programs 436 can each be implemented as single programs, or as separate programs to implement the methods and omnibus fund accounting system described herein. The machine executable code used to execute the computer implemented method steps and create the omnibus fund accounting system described herein are examples of application programs 436 in the described embodiments.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The numerous innovative teachings of the present application will be described with particular reference to the exemplary embodiments. However, it should be understood that this class of embodiments provides only a few examples of the many advantageous uses of the innovative teachings herein. In general, statements made in the specification of the present application do not necessarily limit any of the various claimed inventions. To the contrary, the description of the exemplary embodiments are intended to cover alternative, modifications, and equivalents as may be included within the spirit and scope of the invention as defined by the claims. Moreover, some statements may apply to some inventive features but not to others.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A computer-implemented method comprising:
retrieving investment data from a database for an omnibus fund investment of one or more institutional investors, the investment data comprising data for a plurality of individual investors wherein the data further comprises a unique capital account assigned to each individual investor, an individual investor account balance from a previous time period for each unique capital account, and a unit value of fund units designated to each unique capital account from the previous time period;
determining a return on investment and whether a performance fee applies for each unique capital account for a current time period;
determining an updated account balance for each unique capital account based on at least the individual investor account balance from the previous time period, the return on investment for the current time period, and the performance fee, if one applies, for the current time period;
storing the updated account balance for each unique capital account in the database;
determining an interim NAV for each unique capital account based on the units assigned to that unique capital account during the previous time period and the updated account balance;
storing each interim NAV in the database;
determining an overall fund NAV from among the unique capital account interim NAVs for the current time period; and
determining a new unit value for each unique capital account by dividing the updated account balance by the overall NAV for the current time period.

2. The method of claim 1, wherein the method further comprises determining a unit adjustment value assigned to each unique capital account by subtracting the new unit value by the unit value of the previous time period.

3. The method of claim 2, wherein the method further comprises compiling data indicating the unit adjustments for each unique capital account and reporting the data indicating the unit adjustments for individual investors to the institutional investor.

4. The method of claim 1, wherein the method further comprises a recurring time period that is monthly.

5. The method of claim 1, wherein the method further comprises compiling data indicating the overall net asset value for the current time period and reporting the data indicating the overall net asset value.

6. The method of claim 1, wherein determining an overall fund NAV from among the unique capital account interim NAVs for the current time period comprises selecting the lowest interim NAV from among the unique capital accounts.

7. The method of claim 1, wherein the overall net asset value is the net asset value determined for the units of the entire investment fund.

8. The method of claim 1, wherein the overall net asset value is the net asset value determined for units attributable to each institutional investor in the investment fund.

9. The method of claim 1, wherein the investment data comprises data received from an insurance company institutional investor for the omnibus fund investment.

10. The method of claim 1 further comprising the plurality of individual investors who are insurance policy-holders.

11. A non-transitory computer readable medium comprising instructions to manipulate a processor, the instructions comprising instructions to:
retrieve investment data from a database for an omnibus fund investment of one or more institutional investors, the investment data comprising data for a plurality of individual investors wherein the data further comprises a unique capital account assigned to each individual investor, an individual investor account balance from a previous time period for each unique capital account, and a unit value of fund units designated to each unique capital account from the previous time period;
determine a return on investment and whether a performance fee applies for each unique capital account for a current time period;
determine an updated account balance for each unique capital account based on at least the individual investor account balance from the previous time period, the return on investment for the current time period, and the performance fee, if one applies, for the current time period;
store the updated account balance data for each unique capital account in the database;
determine an interim net asset value for each unique capital account based on the units assigned to that unique capital account during the previous time period and the updated account balance;
storing each interim net asset value in the database;
determine a lowest interim net asset value from among the unique capital account interim net asset values to determine an overall net asset value for the current time period; and
determine a new unit value for each unique capital account by dividing the updated account balance by the overall net asset value for the current time period.

12. The computer readable medium of claim 11, wherein the instructions further comprise: instructions to determine a unit adjustment value assigned to each unique capital account by subtracting the new unit value by the unit value of the previous time period.

13. The computer readable medium of claim 12, wherein the instructions further comprise: instructions to compile data indicating the unit adjustments for each unique capital account and report the data indicating the unit adjustments for individual investors to the institutional investor.

14. The computer readable medium of claim 11 further comprising a recurring time period that is monthly.

15. The computer readable medium of claim 11, wherein the instructions further comprise:
instructions to compile data indicating the overall net asset value for the current time period and report the data indicating the overall net asset value.

16. The computer readable medium of claim 11, wherein the instructions further comprise: instructions to determine an overall fund NAV from among the unique capital account interim NAVs for the current time period by selecting the lowest interim NAV from among the unique capital accounts.

17. The computer readable medium of claim 11, wherein the overall net asset value is the net asset value determined for the units of the entire investment fund.

18. The computer readable medium of claim 11, wherein the overall net asset value is the net asset value determined for units attributable to each institutional investor in the investment fund.

19. The computer readable medium of claim 11, wherein the investment data comprises data received from an insurance company institutional investor for the omnibus fund investment.

20. The computer readable medium of claim 11 further comprising the plurality of individual investors who are insurance policy-holders.
